(19) United States
(12) Patent Application Publication
(10) Pub. No.: US 2006/0155012 A1
(43) Pub. Date: Jul. 13, 2006

(54) Biopolymer including prolamin and methods of making it

(76) Inventor: Michael J. Riebel, Mankato, MN (US)

Correspondence Address: MERCHANT & GOULD PC, P.O. BOX 2903, MINNEAPOLIS, MN, 55402-0903, US

(21) Appl. No.: 11/300,644

(22) Filed: Dec. 13, 2005

Related U.S. Application Data
(60) Provisional application No. 60/636,005, filed on Dec. 13, 2004.

(51) Int. Cl. C08L 89/00; D21H 19/50

(52) U.S. Cl. 524/17

(57) ABSTRACT

The present invention relates to a composition, which can be referred to as a biopolymer, including prolamin and thermoactive material. The present invention also includes methods of making the biopolymer, which can include compounding prolamin and thermoactive material. The present biopolymer can be formed into an article of manufacture.

### CROSS REFERENCE TO RELATED APPLICATIONS

This application claims the benefit of U.S. Provisional Patent Application Ser. No. 60/636,005, filed Dec. 13, 2004, which application is hereby incorporated by reference in its entirety.

### FIELD OF THE INVENTION

The present invention relates to a composition, which can be referred to as a biopolymer, including prolamin and thermoactive material. The present invention also includes methods of making the biopolymer, which can include compounding prolamin and thermoactive material. The present biopolymer can be formed into an article of manufacture.

### BACKGROUND OF THE INVENTION

Fillers have been used in the plastic industry for almost 90 years. The reason most manufacturers use filled plastic is to reduce the price of the high cost of polypropylene and other plastics with lower cost fillers, such as wood flour, talc, mica, and fiberglass. Filled plastics usually improve the characteristics of plastics creating higher thermal stability and higher bending and rupture strengths. Wood flour is used as low cost filler and does not enhance the qualities of plastics tremendously. Talc and mica provide some increase in strength to plastic, but also add weight and decreases the life of the extruder due to abrasion. Fiberglass adds considerable strength of the product, but at a substantial cost. The filled plastic pellets produced are used in high volume markets such as interior automotive panels, molded plastic components, decking, injection-molded products and many other applications.

There are many disadvantages associated with existing biopolymer processes and compositions. A principal problem associated with the extrusion and injection methods is that the particle size of the material used in this process is very small and is primarily ground wood. Otherwise, the viscosity of the aggregate mixture is too high to be extruded or molded efficiently. Moreover, extrusion or injection processes are further limited by the ratio of filler materials, such as wood, to the thermo active materials that can be used in the charge. This puts undesirable constraints on the products that can be produced. Wood plastic aggregates typically use between 30% to 65% wood flour or fine wood saw dust mixed with simple plastics. Ratios higher than this cause both processing problems and overall performance degradation in areas of moisture absorption, rot, decay, moisture stability, and so on.

There remains a need for an inexpensive, biologically derived material that can reduce the cost and consumption of polymers and that performs better than a filler.

### SUMMARY OF THE INVENTION

The present invention relates to a composition, which can be referred to as a biopolymer, including prolamin and thermoactive material. The present invention also includes methods of making the biopolymer, which can include compounding prolamin and thermoactive material. The present biopolymer can be formed into an article of manufacture.

The present invention relates to a composition including prolamin (e.g., zein or kafirin) and thermoactive material. The composition can include wide ranges of amounts of these ingredients. For example, in an embodiment, the composition can include about 5 to about 95 wt-% prolamin and about 1 to about 95 wt-% thermoactive material. The thermoactive material can include, for example, at least one of thermoplastic, thermoset material, and resin and adhesive polymer. The present composition can be employed in any of a variety of articles. The article can include the composition including prolamin (e.g., zein or kafirin) and thermoactive material.

The present invention relates to a method of making a composition including prolamin (e.g., zein or kafirin) and thermoactive material. The method includes compounding ingredients of the composition including but not limited to prolamin (e.g., zein or kafirin) and thermoactive material. Compounding can include thermal kinetic compounding. The composition can be made as a foamed composition. Producing a foamed composition can include extruding material comprising prolamin and thermoactive material; the foamed material need not include blowing or foaming agent.

The present composition can be employed in a method of making an article. This method can include forming the article from a composition including prolamin (e.g., zein or kafirin) and thermoactive material.

### DETAILED DESCRIPTION OF THE INVENTION

Definitions

As used herein, the term “biopolymer” refers to a material including a thermoactive material and a prolamin.

As used herein, the term “prolamin” refers to any of a group of globular proteins that are found in plants, such as cereals. Prolamin proteins are generally soluble in 70-80 per cent alcohol but insoluble in water and absolute alcohol. These proteins contain high levels of glutamic acid and proline. Suitable prolamin proteins include gliadin (wheat and rye), zein (corn), and kafirin (sorghum and millet). Suitable gliadin proteins include α-, β-, γ-, and ω-gliadins.

As used herein, the term “zein” refers to a prolamin protein found in corn, with a molecular weight of about 40,000 (e.g., 38,000), and not containing tryptophan and lysine.

As used herein, the phrase “glass transition point” or “T_{g}” refers to the temperature at which a particle of a material (such as a prolamin or thermoactive material) reaches a “softening point” so that it has a viscoelastic nature and can be more readily compacted. Below T_{g} a material is in its “glass state” and has a form that can not be as readily deformed under simple pressure. As used herein, the phrase “melting point” or “Tₘ ” refers to the temperature at which a material (such as a prolamin or thermoactive material) melts and begins to flow. Suitable methods for measuring these temperatures include differential scanning calorimetry (DSC), dynamic mechanical thermal analysis (DTMA), and thermal mechanical analysis (TMA).

As used herein, the phrase “fermentation solid” refers to solid material recovered from a fermentation process, such as alcohol (e.g., ethanol) production.

As used herein, the phrase “fermented protein solid” refers to fermentation solid recovered from fermenting a material including protein. The fermented protein solid also includes protein.

As used herein, the phrase “distiller's dried grain” (DDG) refers to the dried residue remaining after the starch in grain (e.g., corn) has been fermented with selected yeasts and enzymes to produce products including ethanol and carbon dioxide. DDG can include residual amounts of solubles, for example, about 2 wt-%. Distiller's dried grain includes compositions known as brewer's grain and spent solids.

As used herein, the phrase “distiller's dried grain with solubles” (DDGS) refers to a dried preparation of the coarse material remaining after the starch in grain (e.g., corn) has been fermented plus the soluble portion of the residue remaining after fermentation, which has been condensed by evaporation to produce solubles. The solubles can be added to the DDG to form DDGS.

As used herein, the phrase “wet cake” or “wet distiller's grain” refers to the coarse, wet residue remaining after the starch in grain (e.g., corn) has been fermented with selected yeasts and enzymes to produce products including ethanol and carbon dioxide.

As used herein, the phrase “solvent washed wet cake” refers to wet cake that has been washed with a solvent such as, water, alcohol, or hexane.

As used herein, the phrase “gluten meal” refers to a by-product of the wet milling of plant material (e.g., corn, wheat, or potato) for starch. Corn gluten meal can also be a by-product of the conversion of the starch in whole or various fractions of dry milled corn to corn syrups. Gluten meal includes prolamin protein and gluten (a mixture of water-insoluble proteins that occurs in most cereal grains) and also smaller amounts of fat and fiber.

As used herein, the phrase “plant material” refers to all or part of any plant (e.g., cereal grain), typically a material including starch. Suitable plant material includes grains such as maize (corn, e.g., whole ground corn), sorghum (milo), barley, wheat, rye, rice, millet, oats, soybeans, and other cereal or leguminous grain crops; and starchy root crops, tubers, or roots such as sweet potato and cassava. The plant material can be a mixture of such materials and byproducts of such materials, e.g., corn fiber, corn cobs, stover, or other cellulose and hemicellulose containing materials such as wood or plant residues. Preferred plant materials include corn, either standard corn or waxy corn. Preferred plant materials can be fermented to produced fermentation solid.

As used herein, weight percent (wt-%), percent by weight, % by weight, and the like are synonyms that refer to the concentration of a substance as the weight of that substance divided by the weight of the composition and multiplied by 100. Unless otherwise specified, the quantity of an ingredient refers to the quantity of active ingredient.

As used herein, the term “about” modifying any amount refers to the variation in that amount encountered in real world conditions of producing materials such as polymers or composite materials, e.g., in the lab, pilot plant, or production facility. For example, an amount of an ingredient employed in a mixture when modified by about includes the variation and degree of care typically employed in measuring in a plant or lab producing a material or polymer. For example, the amount of a component of a product when modified by about includes the variation between batches in a plant or lab and the variation inherent in the analytical method. Whether or not modified by about, the amounts include equivalents to those amounts. Any quantity stated herein and modified by “about” can also be employed in the present invention as the amount not modified by about.

The Biopolymer

The present invention relates to a biopolymer that includes one or more prolamins and one or more thermoactive materials. The present biopolymer can exhibit properties typical of plastic materials, properties advantageous compared to conventional plastic materials, and/or properties advantageous compared to aggregates including plastic and, for example, wood or cellulosic materials. The present biopolymer can be formed into useful articles using any of a variety of conventional methods for forming items from plastic. The present biopolymer can take any of a variety of forms.

In an embodiment, the present biopolymer includes prolamin integrated with the thermoactive material. A biopolymer including prolamin integrated into the thermoactive material is referred to herein as an “integrated biopolymer”. An integrated biopolymer can include covalent bonding between the thermoactive material and the prolamin. In an embodiment, the integrated biopolymer forms a uniform mass in which the prolamin has been blended into the thermoactive material.

In an embodiment, the present biopolymer includes visible particles of remaining prolamin. A biopolymer including visible particles of remaining prolamin is referred to herein as a “composite biopolymer”. In an embodiment, even in a composite biopolymer, a significant fraction of the prolamin can be blended into and/or bond with the thermoactive material. In an embodiment, a composite biopolymer can form a single substance from which the particles of prolamin can not be removed.

In yet another embodiment, the present biopolymer includes a significant portion of prolamin present as discrete particles surrounded by or embedded in the thermoactive material. A biopolymer including discrete particles of prolamin surrounded by or embedded in the thermoactive material is referred to herein as an “aggregate biopolymer”. In such an aggregate biopolymer, the significant portion of prolamin present as discrete particles can be considered an extender or a filler. Nonetheless, a minor portion of the prolamin can be blended into and/or bond with the thermoactive material.

In an embodiment, the compounded prolamin and thermoactive material (i.e., the soft or raw biopolymer), before hardening, takes the form of a dough, which can be largely homogeneous. As used herein, “largely homogeneous” dough refers to a material with a consistency similar to baking dough (e.g., bread or cookie dough) with a major proportion of the prolamin blended into the thermoactive material and no longer appearing as distinct particles. In an embodiment, the soft or raw biopolymer includes no detectable particles of prolamin, e.g., it is a homogeneous dough. In an embodiment, the soft or raw biopolymer can include up to 95 wt-% (e.g., 90 wt-%) prolamin and take the form of a largely homogeneous or homogeneous dough. In an embodiment, the soft or raw biopolymer can include about 50 to about 70 wt-% prolamin and take the form of a largely homogeneous or homogeneous dough.

In an embodiment, the raw or soft biopolymer includes visible amounts of prolamin. As used herein, visible amounts of prolamin refers to particles that are clearly visible to the naked eye and that provide a speckled appearance to the cured biopolymer. Such visible prolamin can be colored for decorative effect in the cured biopolymer. The speckled appearance can be produced by employing larger particles of prolamin than used to produce a homogeneous or largely homogeneous dough.

In certain embodiments, the biopolymer can include prolamin at about 0.01 to about 95 wt-%, about 1 to about 95 wt-%, about 5 to about 95 wt-%, about 5 to about 80 wt-%, about 5 to about 70 wt-%, about 5 to about 20 wt-%, about 50 to about 95 wt-%, about 50 to about 80 wt-%, about 50 to about 70 wt-%, about 50 to about 60 wt-%, about 60 to about 80 wt-%, or about 60 to about 70 wt-%. In certain embodiments, the biopolymer can include prolamin at about 5 wt-%, about 10 wt-%, about 20 wt-%, about 50 wt-%, about 60 wt-%, about 70 wt-%, or about 75 wt-%. The present biopolymer can include any of these amounts or ranges not modified by about.

In certain embodiments, the biopolymer can include thermoactive material at about 0.01 to about 95 wt-%, about 1 to about 95 wt-%, about 5 to about 30 wt-%, about 5 to about 40 wt-%, about 5 to about 50 wt-%, about 5 to about 85 wt-%, about 5 to about 95 wt-%, about 10 to about 30 wt-%, about 10 to about 40 wt-%, about 10 to about 50 wt-%, or about 10 to about 95 wt-%. In certain embodiments, the biopolymer can include thermoactive material at about 95 wt-%, about 75 wt-%, about 50 wt-%, about 45 wt-%, about 40 wt-%, about 35 wt-%, about 30 wt-%, about 25 wt-%, about 20 wt-%, about 15 wt-%, about 10 wt-%, or about 5 wt. The present biopolymer can include any of these amounts or ranges not modified by about.

In certain embodiments, the biopolymer can include prolamin at about 5 to about 95 wt-% and thermoactive material at about 5 to about 95 wt-%, can include prolamin at about 50 to about 70 wt-% and thermoactive material at about 30 to about 70 wt-%, can include prolamin at about 50 to about 70 wt-% and thermoactive material at about 20 to about 70 wt-%, can include prolamin at about 50 to about 60 wt-% and thermoactive material at about 30 to about 50 wt-%, or can include prolamin at about 60 to about 70 wt-% and thermoactive material at about 20 to about 40 wt-%. In certain embodiments, the biopolymer can include about 5 wt-% prolamin and about 70 to about 95 wt-% thermoactive material, about 10 wt-% prolamin and about 70 to about 90 wt-% thermoactive material, about 50 wt-% prolamin and about 30 to about 50 wt-% thermoactive material, about 55 wt-% prolamin and about 30 to about 45 wt-% thermoactive material, about 60 wt-% prolamin and about 20 to about 40 wt-% thermoactive material, about 65 wt-% prolamin and about 20 to about 35 wt-% thermoactive material, about 70 wt-% prolamin and about 10 to about 30 wt-% thermoactive material, about 90 wt-% prolamin and about 5 to about 10 wt-% thermoactive material. The present biopolymer can include any of these amounts or ranges not modified by about.

Embodiments of Biopolymers

In an embodiment, the present biopolymer can have higher thermal conductivity than conventional thermoplastics. For example, in an embodiment, the present biopolymer can cool or heat faster than the thermoactive material without prolamin. In an embodiment, the present biopolymer can cool as rapidly as the apparatus forming it can operate. Although not limiting to the present invention, it is believed that such increased thermal conductivity can be due to the nature of the prolamin. For example, the increased thermal conductivity may be due to integration of the prolamin into the thermoactive material.

In an embodiment, the present biopolymer has a speckled appearance. Biopolymer with a speckled appearance can include larger particles of prolamin than an integrated biopolymer. For example, prolamin of a size of about 2 to about 10 mesh can be employed to form biopolymer with a speckled appearance. In an embodiment, a biopolymer including such larger prolamin has flow characteristics suitable or even advantageous for compounding and forming. In an embodiment, a biopolymer including such a larger prolamin takes the form of a composite biopolymer.

In an embodiment, the present biopolymer includes both prolamin and fermentation solid. As used herein, a biopolymer “consisting essentially of” prolamin and thermoactive material includes prolamin, thermoactive material, and can optionally include other ingredients (such as one or more additives), but does not include fermentation solid.

Prolamin

Prolamin suitable for the present biopolymer can have a wide range of moisture content. In an embodiment, the moisture content can be less than or equal to about 15 wt-%, for example about 1 to about 15 wt-%. In an embodiment, the moisture content can be about 5 to about 15 wt-%. In an embodiment, the moisture content can be about 5 to about 10 (e.g., 12) wt-%. In an embodiment, the moisture content can be about 5 (e.g., 6) wt-%.

The present biopolymer can include or can be made from a prolamin with any of broad range of sizes. In certain embodiments, the prolamin employed in the biopolymer has a particle size of about 2 mesh to less than about 1 micron, about 2 to about 10 mesh, about 12 to about 500 mesh, about 60 mesh to less than about 1 micron, about 60 mesh to about 1 micron, about 60 to about 500 mesh.

In certain embodiments, the prolamin employed in the biopolymer can be or has been treated before compounding by coloring, grinding and screening (e.g., to a uniform range of sizes), drying, or any of a variety of procedures known for treating agricultural material before mixing with thermoactive material.

In certain embodiments, the biopolymer can include prolamin at about 0.01 to about 95 wt-%, about 1 to about 95 wt-%, about 5 to about 95 wt-%, about 5 to about 80 wt-%, about 5 to about 70 wt-%, about 50 to about 95 wt-%, about 50 to about 80 wt-%, about 50 to about 70 wt-%, about 50 to about 60 wt-%, about 60 to about 80 wt-%, or about 60 to about 70 wt-%. In certain embodiments, the biopolymer can include prolamin at about 5 wt-%, about 10 wt-%, about 50 wt-%, about 60 wt-%, about 70 wt-%, or about 75 wt-%. The present biopolymer can include any of these amounts or ranges not modified by about.

Embodiments of Prolamin

Although not limiting to the present invention, in certain embodiments, it is believed that the present prolamin can be advantageously suited for forming biopolymers. For example, in an embodiment, the present prolamin can be characterized by or can have a glass transition point (T_{g}) and/or a melting point (Tₘ). For example, in an embodiment, the present prolamin can form an integral biopolymer. Although not limiting to the present invention, it is believed that an embodiment of an integral biopolymer can include covalent bonding between the prolamin and the thermoactive material. By way of further example, in an embodiment, it is believed that the present prolamin imparts desirable thermal conductivity (e.g., advantageously rapid heating and cooling) to the biopolymer.

Although not limiting to the present invention, it is believed that, in certain embodiments, the present prolamin can be characterized with reference to two temperatures, a glass transition point (T_{g}) and a melting point (Tₘ). In an embodiment, the prolamin can be compounded at a temperature at which it exhibits viscoelastic properties, e.g. between T_{g} and Tₘ. In an embodiment, the prolamin can be compounded at a temperature at which it has melted or can melt, e.g., at or above Tₘ. In an embodiment, the biopolymer includes a thermoactive material with a melting point less than about T_{g} for the prolamin. In an embodiment, the biopolymer includes a thermoactive material with a melting point less than about Tₘ for the prolamin. In an embodiment, the prolamin can have Tₘ approximately equal to that of the polymer.

Although not limiting to the present invention, it is believed that compounding the prolamin with the thermoactive material at a temperature below T_{g} and/or below Tₘ for the prolamin will not produce an integral biopolymer or a soft or raw biopolymer in the form of a dough.

The Tₘ of the prolamin can be related to its content of oil or syrup (e.g., solubles) from plant material or other additives. In an embodiment, the Tₘ of the prolamin can be selected by controlling the amount of oil or syrup (e.g., solubles) in the material. For example, it is believed that higher oil or syrup (e.g., solubles) content decreases Tₘ and T_{g} and lower oil or syrup (e.g., solubles) content increases Tₘ.

The Tₘ of prolamin can be related to its content of plasticizer (e.g., water, liquid polymer, liquid thermal plastic, fatty acid, or the like). In an embodiment, the Tₘ of the prolamin can be selected by controlling the amount of plasticizer in the material. For example, it is believed that higher plasticizer content decreases Tₘ and T_{g} and lower plasticizer content increases Tₘ.

Although not limiting to the present invention, it is believed that compounding the present biopolymer at temperatures between T_{g} and Tₘ of the prolamin provides advantageous interaction between the thermoactive material and the prolamin, which can result in a biopolymer with advantageous properties. In an embodiment, the selected temperature is also above the melting point of the thermoactive material and suitable for compounding with the thermoactive material. In certain embodiments, the T_{g} and Tₘ of the prolamin allow compounding with polymers with a relatively high melting point, such as polyethylene terephthalate (PET), polycarbonate, and other engineered plastics.

In an embodiment, the present biopolymer can have advantageous flow characteristics compared to simple thermal plastics. The melt flow index represents the ability of a plastic material to flow. The higher the melt flow index the easier the material flows at a specified temperature. Melt flow index can be measured by a standard test known as MFR or MFI.

Briefly, the test includes a specific force, produced by an accurate weight, extruding a heated plastic material through a circular die of a fixed size, at a specified temperature. The amount of thermoactive material extruded in 10 minutes is called the MFR. This test is defined by standard plastics testing method ASTM D 3364.

Most olefin thermal plastics are tested at a temperature of 230° C. It is believed that the present biopolymer can achieve the melt index of a homogeneous thermoactive material but at a lower temperature. For example, consider a plastic with a melt index of 10 at 230° C. This plastic can be employed as the thermoactive material in the present biopolymer at a level of only about 30 wt-% thermoactive material and about 70 wt-% of prolamin. It is believed that the resulting biopolymer will have a melt index of about 10 at a temperature lower than 230° C. Similarly, it is believed that the resulting biopolymer will have a melt flow index lower than 10 at 230° C. Such advantageous flow characteristics can allow processing present biopolymer at lower temperatures. Processing at lower temperatures can save energy and provide for faster cooling.

In contrast, filled plastics such as wood/plastic, fiber filled plastics, mineral filled plastics and other inert fillers typically decrease the melt index of the thermoactive material, which results in less flow or greater force required to induce flow. Thus, these conventional filled plastics are harder to process compared to the pure plastic and can require higher temperatures to process and maintain melt flow index.

Thermoactive Material

The biopolymer can include any of a wide variety of thermoactive materials. For example, the biopolymer can include any thermoactive material in which the prolamin can be embedded. In an embodiment, the thermoactive material can be selected for its ability to form a homogeneous or largely homogeneous dough including the prolamin. In an embodiment, the thermoactive material can be selected for its ability to covalently bond with the prolamin. In an embodiment, the thermoactive material can be selected for its ability to flow when mixed or compounded with prolamin. In an embodiment, the thermoactive material can set after being formed. Numerous such thermoactive materials are commercially available.

Suitable thermoactive materials include thermoplastic, thermoset material, a resin and adhesive polymer, or the like. As used herein, the term “thermoplastic” refers to a plastic that can once hardened be melted and reset. As used herein, the term “thermoset” material refers to a material (e.g., plastic) that once hardened cannot readily be melted and reset. As used herein, the phrase “resin and adhesive polymer” refers to more reactive or more highly polar polymers than thermoplastic and thermoset materials.

Suitable thermoplastics include polyamide, polyolefin (e.g., polyethylene, polypropylene, poly(ethylene-copropylene), poly(ethylene-coalphaolefin), polybutene, polyvinyl chloride, acrylate, acetate, and the like), polystyrenes (e.g., polystyrene homopolymers, polystyrene copolymers, polystyrene terpolymers, and styrene acrylonitrile (SAN) polymers), polysulfone, halogenated polymers (e.g., polyvinyl chloride, polyvinylidene chloride, polycarbonate, or the like, copolymers and mixtures of these materials, and the like. Suitable vinyl polymers include those produced by homopolymerization, copolymerization, terpolymerization, and like methods. Suitable homopolymers include polyolefins such as polyethylene, polypropylene, poly-1-butene, etc., polyvinylchloride, polyacrylate, substituted polyacrylate, polymethacrylate, polymethylmethacrylate, copolymers and mixtures of these materials, and the like. Suitable copolymers of alpha-olefins include ethylene-propylene copolymers, ethylene-hexylene copolymers, ethylene-methacrylate copolymers, ethylene-methacrylate copolymers, copolymers and mixtures of these materials, and the like. In certain embodiments, suitable thermoplastics include polypropylene (PP), polyethylene (PE), and polyvinyl chloride (PVC), copolymers and mixtures of these materials, and the like. In certain embodiments, suitable thermoplastics include polyethylene, polypropylene, polyvinyl chloride (PVC), low density polyethylene (LDPE), copoly-ethylene-vinyl acetate, copolymers and mixtures of these materials, and the like.

Suitable thermoset materials include epoxy materials, melamine materials, copolymers and mixtures of these materials, and the like. In certain embodiments, suitable thermoset materials include epoxy materials and melamine materials.

Suitable resin and adhesive polymer materials include resins such as condensation polymeric materials, vinyl polymeric materials, and alloys thereof. Suitable resin and adhesive polymer materials include polyesters (e.g., polyethylene terephthalate, polybutylene terephthalate, and the like), methyl diisocyanate (urethane or MDI), organic isocyanide, aromatic isocyanide, phenolic polymers, urea based polymers, copolymers and mixtures of these materials, and the like. Suitable resin materials include acrylonitrile-butadiene-styrene (ABS), polyacetyl resins, polyacrylic resins, fluorocarbon resins, nylon, phenoxy resins, polybutylene resins, polyarylether such as polyphenylether, polyphenylsulfide materials, polycarbonate materials, chlorinated polyether resins, polyethersulfone resins, polyphenylene oxide resins, polysulfone resins, polyimide resins, thermoplastic urethane elastomers, copolymers and mixtures of these materials, and the like. In certain embodiments, suitable resin and adhesive polymer materials include polyester, methyl diisocyanate (urethane or MDI), phenolic polymers, urea based polymers, and the like.

Suitable thermoactive materials include polymers derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like.

Suitable thermoactive materials include thermoplastic elastomers, such as thermoplastic polyurethanes, vulcanized thermoplastic polyolefins, thermoplastic vulcanizate, and the like. Suitable thermoplastic polyurethane can be or include an aromatic polyester-based thermoplastic polyurethane. Such thermoplastic polyurethanes are commercially available under the tradenames TEXIN® (e.g., TEXIN® 185) or DESMOPAN® from Bayer. Suitable thermoplastic elastomers are known and commercially available from any of a variety of sources. Suitable thermoplastic elastomers include thermoplastic vulcanizate sold under the tradename SARLINK®.

In certain embodiments, the biopolymer can include thermoactive material at about 0.01 to about 95 wt-%, about 1 to about 95 wt-%, about 5 to about 30 wt-%, about 5 to about 40 wt-%, about 5 to about 50 wt-%, about 5 to about 85 wt-%, about 5 to about 95 wt-%, about 10 to about 30 wt-%, about 10 to about 40 wt-%, about 10 to about 50 wt-%, or about 10 to about 95 wt-%. In certain embodiments, the biopolymer can include thermoactive material at about 95 wt-%, about 75 wt-%, about 50 wt-%, about 45 wt-%, about 40 wt-%, about 35 wt-%, about 30 wt-%, about 25 wt-%, about 20 wt-%, about 15 wt-%, about 10 wt-%, or about 5 wt. The present biopolymer can include any of these amounts or ranges not modified by about.

Embodiments of Thermoactive Materials

In an embodiment, the present biopolymer includes a thermoactive material supplied as a liquid (e.g., MDI). The liquid thermoactive material can provide advantageous characteristics to the biopolymer. MDI, organic isocyanide, aromatic isocyanide, phenol, melamine, and urea based polymers, and the like can be considered high moisture content polymers, which can be advantageous for extrusion. Such thermoactive materials can be employed to create a foamed extrusion for lower weight applications.

Additives

The present biopolymer can also include one or more additives. Suitable additives include one or more of dye, pigment, other colorant, hydrolyzing agent, plasticizer, filler, extender, preservative, antioxidants, nucleating agent, antistatic agent, biocide, fungicide, fire retardant, flame retardant, heat stabilizer, light stabilizer, conductive material, water, oil, lubricant, impact modifier, coupling agent, crosslinking agent, blowing or foaming agent, reclaimed or recycled plastic, and the like, or mixtures thereof. Suitable additives include plasticizer, light stabilizer, coupling agent, and the like, or mixtures thereof. In certain embodiments, additives can tailor properties of the present biopolymer for end applications. In an embodiment, the present biopolymer can optionally include about 1 to about 20 wt-% additive.

Hydrolyzing Agent

Hydrolyzing prolamin can be accomplished with a highly alkaline aqueous solution containing an alkaline dispersion agent, such as a strong inorganic or organic base. The base is preferably a strong inorganic base, such as: KOH, NaOH, CaOH, NH₄OH, hydrated lime or combination thereof. Hydrolyzing can be accomplished by mechanical methods of heat and pressure. Hydrolysis can be accomplished by lowering the pH of the admixture. Chemical compounds such as maleic acid or maleated polypropylene can be added to the prolamin. Maleated polypropylenes such as G-3003 and G-3015 manufactured by Eastman chemicals are examples of hydrolysis materials. The prolamin and thermoactive material can crosslink via the hydrolysis process and the molding process conditions (high temperature and high pressure). In an embodiment, the present biopolymer can optionally include about 0.01 to about 20 wt-% hydrolyzing agent.

Plasticizer

Conventional plasticizers can be employed in the present biopolymer. Plasticizers can modify the performance of the biopolymer, for example, by making it more flexible and/or changing flow characteristics. The present biopolymer can include plasticizer in amounts employed in conventional plastics. Suitable plasticizers include natural or synthetic compounds such as at least one of polyethylene glycol, polypropylene glycol, polyethylene-propylene glycol, triethylene glycol, diethylene glycol, dipropylene glycol, propylene glycol, ethylene glycol, glycerol, glycerol monoacetate, diglycerol, glycerol diacetate or triacetate, 1,4-butanediol, diacetin sorbitol, sorbitan, mannitol, maltitol, polyvinyl alcohol, sodium cellulose glycolate, urea, cellulose methyl ether, sodium alginate, oleic acid, lactic acid, citric acid, sodium diethylsuccinate, triethyl citrate, sodium diethylsuccinate, 1,2,6-hexanetriol, triethanolamine, polyethylene glycol fatty acid esters, oils, expoxified oils, natural rubbers, other known plasticizers, mixtures or combinations thereof, and the like. In certain embodiments, the present biopolymer can optionally include about 1 to about 15 wt-% plasticizer, about 1 to about 30 wt-% plasticizer, or about 1 to about 50 wt-% plasticizer.

Crosslinking Agent

Crosslinking agents have been found to decrease the creep observed with plastic composite products and/or can modify water resistance. Crosslinking agents also have the ability to increase the mechanical and physical performance of the present biopolymer. As used herein, crosslinking refers to linking the thermoactive material and the prolamin. Crosslinking is distinguished from coupling agents which form bonds between plastic materials. Suitable crosslinking agents include one or more of metallic salts and salt hydrates (which may improve mechanical properties), formaldehyhde, urea formaldehyde, phenol and phenolic resins, melamine, methyl diisocyanide (MDI), other adhesive or resin systems, mixtures of combinations thereof, and the like. In an embodiment, the present biopolymer can optionally include about 1 to about 20 wt-% crosslinking agent.

Lubricant

In an embodiment, the present biopolymer can include a lubricant. A lubricant can alter the fluxing (melting) point in a compounding, extrusion, or injection molding process to achieve desired processing characteristics and physical properties.

Lubricants can be categorized as external, internal, and external/internal. These categories are based on the effect of the lubricant on the melt in a plasticizing screw or thermal kinetic compounding device as follows. External lubricants can provide good release from metal surfaces and lubricate between individual particles or surface of the particles and a metal part of the processing equipment. Internal lubricants can provide lubrication within the composition, for example, between resin particles, and can reduce the melt viscosity. Internal/external lubricants can provide both external and internal lubrication.

Suitable external lubricants include non-polar molecules or alkanes, such as at least one of paraffin wax, mineral oil, polyethylene, mixtures or combinations thereof, and the like. Such lubricants can help the present biopolymer (for example, those including PVC) slip over the hot melt surfaces of dies, barrel, and screws without sticking and contribute to the gloss on the end product surface. In addition an external lubricant can maintain the shear point and reduce overheating of the biopolymer.

Suitable internal lubricants include polar molecules, such as at least one of fatty acids, fatty acid esters, metal esters of fatty acids, mixtures or combinations thereof, and the like. Internal lubricants can be compatible with thermoactive materials such as olefins, PVC, and other thermally active materials and the prolamin. These lubricants can lower melt viscosity, reduce internal friction and related heat due to internal friction, and promote fusion.

Certain lubricants can also be natural plasticizers. Suitable natural plasticizer lubricants include at least one of oleic acid, linoleic acid, polyethylene glycol, glycerol, steric acid, palmitic acid, lactic acid, sorbitol, wax, epoxified oil (e.g., soybean), heat embodied oil, mixtures or combinations thereof, and the like.

In an embodiment, the present biopolymer can optionally include about 1 to about 10 wt-% lubricant.

Processing Aid

In an embodiment, the present biopolymer includes a processing aid. Suitable processing aids include acrylic polymers and alpha methylstyrene. These processing aids can be employed with a PVC polymer. A processing aid can reduce or increase melt viscosity and reduce uneven die flow. In a thermoactive material material, it promotes fluxing and acts like an internal lubricant. Increasing levels of processing aids normally allow lower compounding, extrusion, injection molding processing temperatures. In an embodiment, the present biopolymer can optionally include about 1 to about 10 wt-% processing aid.

Impact Modifier

In an embodiment, the present biopolymer includes an impact modifier. Certain applications require higher impact strength than a simple plastic. Suitable impact modifiers include acrylic, chlorinated polyethylene (CPE), methacryalate-butadiene-styrene (MBS), and the like. These impact modifiers can be employed with a PVC thermoactive material. In an embodiment, the present biopolymer can optionally include about 1 to about 10 wt-% impact modifier.

Filler

The present biopolymer need not but can include a filler. Fillers can reduce the cost of the material and can, in certain embodiments, enhance properties such as hardness, stiffness, and impact strength. Filler can improve the characteristic of the biopolymer, for example, by increasing thermal stability, increasing flexibility or bending, and improving rupture strength. In an embodiment, the present biopolymer can be in the form of a cohesive substance that can bind inert filler (such as wood, fiber, fiberglass, etc.) with petroleum based thermoactive materials. Fillers such as wood flour do not particularly enhance the qualities of filled plastic or biopolymer. Conventional fillers such as talc and mica provide increased impact resistance to the present biopolymer, but add weight and decrease the life of an extruder. Fiberglass as a filler adds considerable strength to the product, but at a relatively high cost. In an embodiment, the present biopolymer can optionally include about 1 to about 50 wt-% filler.

Wood flour and some other fillers used in plastics are not thermally stable. Wood flour does not mix or crosslink with plastics and individual particles are surrounded with plastics under heat and pressure conditions. Mineral, fiberglass, and wood flour are called “inert” fillers due to the fact they can not crosslink or bond to the plastic. Also, wood or cellulose based fillers can not handle the heat requirements of most plastic processes (such as extrusion and injection molding). Additionally, wood flour fillers degrade and retain moisture.

Fiber

The present biopolymer can include a fiber additive. Suitable fibers include any of a variety of natural and synthetic fibers, such as at least one of wood; agricultural fibers including flax, hemp, kenaf, wheat, soybean, switchgrass, or grass; synthetic fibers including fiberglass, Kevlar, carbon fiber, nylon; mixtures or combinations thereof, and the like. The fiber can modify the performance of the biopolymer. For example, longer fibers can be added to biopolymer structural members to impart higher flexural and rupture modulus. In an embodiment, the present biopolymer can include about 1 to about 20 wt-% fiber.

Blowing Agent

Even when produced in the form of a foam, the present biopolymer composition need not include or employ a blowing agent. However, for certain applications for producing the composition in the form of a foam, the biopolymer can include or the process employ a blowing agent. Suitable blowing agents include at least one of pentane, carbon dioxide, methyl isobutyl ketone (MIBK), acetone, and the like.

Urea

In an embodiment, the present biopolymer can include urea as an additive. Urea as an additive can advantageously increase thermal conductivity of the present biopolymer and/or provide advantageous flow characteristics as a feature of the present biopolymer. Of course, urea is not required for such advantages. Urea can be added to the present biopolymer during making this material, such as during thermal kinetic compounding.

Methods of Making the Biopolymer

The present biopolymer can be made by any of a variety of methods that can mix thermoactive material and prolamin. In an embodiment, the thermoactive material and prolamin are compounded. As used herein, the verb “compound” refers to putting together parts so as to form a whole and/or forming by combining parts (e.g., thermoactive material and prolamin). The prolamin can be compounded with any of a variety of thermoactive materials, such as thermoset and thermoplastic materials. Any of a variety of additives or other suitable materials can be mixed or compounded with the prolamin and thermoactive material to make the present biopolymer. In an embodiment, compounding prolamin and thermoactive material produces the dough-like material described hereinabove.

Compounding can include one or more of heating the prolamin and thermoactive material, mixing (e.g., kneading) the prolamin and thermoactive material, and crosslinking the prolamin and thermoactive material. Compounding can include thermal kinetic compounding, extruding, high shear mixing compounding, or the like. In an embodiment, the prolamin and thermoactive material are compounded in the presence of hydrolyzing agent.

The biopolymer or biopolymer dough can be formed by melting together the prolamin and the thermoactive material. In contrast, thermal kinetic compounding of wood particles and thermoactive material produces a material in which wood particles are easily seen as individual particles suspended in the plastic matrix or as wood particles coated with plastic. Advantageously, the compounded prolamin and thermoactive material can be an integrated mass that is homogenous or nearly so.

The compounded, raw or soft biopolymer can be used directly or can be formed as pellets, granules, or another convenient form for converting to articles by molding or other processes.

Thermal Kinetic Compounding

Thermal Kinetic Compounding (“TKC”) can mix and compound employing high speed thermal kinetic principals. Thermal kinetic compounding includes mixing two or more components with high shear speeds using an impeller. Suitable thermal kinetic compounding apparatus are commercially available, for example, the Gelimat G1 (Draiswerke Company). Such a system can include a computer controlled metering and weight batch system.

An embodiment of a thermal kinetic compounding apparatus includes a horizontally positioned mixer and compounding chamber with a central rotating shaft. Several staggered mixing elements are mounted to the shaft at different angles. The specific number and positions of the mixing blades varies with the size of the chamber. A pre-measured batch of thermoactive material and prolamin can be fed in to the compounder, for example, via an integrated screw which can be part of the rotor shaft. Alternatively, the thermoactive material and prolamin can be fed through a slide door, located on the mixer body. The apparatus can include an automatically operated discharge door at the bottom of the compounding chamber.

In the compounding chamber, the thermoactive material and prolamin is subject to extremely high turbulence, due to high tip-speed of the mixing element. The thermoactive material and prolamin are well mixed and also subjected to temperature increase from impact against the chamber wall, mixing blades, and the material particles themselves. The friction in the moving particles can rapidly increase temperature and remove moisture.

The mixture of thermoactive material and prolamin striking the interior of the chamber heats the material. For example, the material can be heated to about 140° C. to about 250° C. in times as short as about 5 to about 30 seconds. The process cycle can be microprocessor controlled. The microprocessor can monitor parameters such as energy, input, temperature, and/or time. When the microprocessor determines that the process is complete, the apparatus can open the discharge door and discharge of the compounded thermoactive material and prolamin (the biopolymer). In an embodiment, the discharged compounded thermoactive material and prolamin is a uniformly blended, fluxed compound, which can immediately be processed.

Using the commercially available thermal kinetic compounding apparatus identified above, the energy consumed by blending, dispersing, and fluxing can be about 0.04 kilowatt per pound of product, which compares favorably to 0.06-0.12 kilowatt per pound of product produced by standard twin-screw compounding systems.

The compounded thermoactive material and prolamin, the biopolymer, can then be run through a regrinding process to produce uniform granular materials. Such regrinding can employ a standard knife grinding system using a screen, which can create smaller uniform particles of a similar size and shape. Such granular materials can be used in, for example, extrusion, injection molding, and other plastic processing.

In an embodiment, TKC processes expose the thermoactive material and prolamin to high temperatures and shear stresses for only a short or reduced time. The duration of TKC can be selected to prevent or reduce thermal degradation.

In an embodiment, thermal kinetic compounding operates on a mixture of as little as 10 wt-% thermoactive material and as much as 90 wt-% prolamin. Such high proportions of prolamin are difficult to compound with a conventional twin-screw compounding system. In an embodiment, using thermal kinetic compounding, product formulations can be changed rather quickly. The chamber of the apparatus can remain clean upon compounding the prolamin and thermoactive material. In an embodiment, quick startup and shut down procedures are also possible in the thermal kinetic compounding apparatus as compared to standard compounding systems that require long and extensive shutdown and cleanout processes.

Although not limiting to the present invention, thermal kinetic compounding can quickly raise the temperature of the material including prolamin to the boiling point of water, at which point vaporization of water slows the temperature rise. Once the moisture content of the material in the compounding chamber decreases below several tenths of a percent, a fast rise in temperature can occur until it reaches the Tₘ point of the admixture of the thermoactive material and the prolamin. Residence time in the chamber can be from about 10 to about 30 seconds. The residence time can be selected based on variables such as diffusion constant time of the particles, initial moisture content, and the like.

Thermal kinetic compounding of prolamin and thermoactive material can employ various processing parameters to produce a desirable biopolymer. In an embodiment, compounding continues until the material(s) have reached or exceeded their Tₘ points.

In an embodiment, thermal kinetic compounding of prolamin and thermoactive material produces a soft or raw biopolymer in the form of a dough, which can be largely homogeneous. For example, thermal kinetic compounding can produce a material with a consistency similar to baking dough (e.g., bread or cookie dough) with a major proportion of the prolamin blended into the thermoactive material and no longer appearing as distinct particles. In an embodiment, thermal kinetic compounding can produce a soft or raw biopolymer with greater than or equal to 70-90 wt-% of the prolamin homogenized into the dough. In an embodiment, thermal kinetic compounding can produce a soft or raw biopolymer including no detectable particles of prolamin.

In an embodiment, thermal kinetic compounding can melt together the prolamin and the thermoactive material. In contrast, thermal kinetic compounding of wood particles and thermoactive material produces a material in which wood particles are easily seen as individual particles suspended in the plastic matrix or as wood particles coated with plastic. Advantageously, in an embodiment, thermal kinetic compounding can compound prolamin and thermoactive material to form an integrated mass that is homogenous or nearly so.

In an embodiment, thermal kinetic compounding can produce raw or soft biopolymer including visible amounts of prolamin. Such compounding can employ particles of prolamin with a size of about 2 to about 20 mesh.

Thermal kinetic compounding can include compounding the quantities or concentrations listed above for the prolamin and thermoactive materials in batch sized suitable for the apparatus. In an embodiment, thermal kinetic compounding can effectively compound prolamin with small amounts of thermoactive material (e.g., about 5 to about 10 wt-% thermoactive material) and produce a raw or soft biopolymer. Such amounts of thermoactive material are small compared to those employed for conventional processes of compounding plant materials, such as wood, with thermoactive materials.

Compounding by Extruding

The present biopolymer can be formed by any of a variety of extruding processes suitable for mixing or compounding prolamin and thermoactive material. For example, conventional extruding processes, such as twin screw compounding, can be employed to make the present biopolymer. Compounding by extruding can provide a higher internal temperature within the extruder and promote the interaction of thermoplastics with the prolamin. Twin screw compounding can employ co- or counter-rotating screws. The extruder can include vents that allow escape of moisture or volatiles from the mixture being compounded.

Removal of Water and Other Matter

Processing machinery (such as an extruder) can be configured to remove water or other matter (gases, liquids, or solids) during processing of materials to form the biopolymer. Water may be extracted for example during twin screw extruding processes or during thermokinetic compounding processes. For clarity, reference hereinafter is made to extraction of water but it is understood that other liquids, gasses, or solids, such as impurities, decomposition products, gaseous by products, and the like, can be extracted as well.

In an embodiment, water can be extracted mechanically. For example, compression forces can be applied during extrusion processes to press water from the material. In an embodiment, compressing the material during extrusion can press water or other liquids or gases out of internal cells that can form in the material.

Heat can also be used to extract water and/or dry the material. In an embodiment, heat can be applied during the extrusion process or during other mechanical water-extraction processes. In an embodiment, after the extrusion or compression molding process, the biopolymer can be immediately processed through a microwave or hot air drying system to remove the balance of water to the equilibrium point of the material. This is typically between 3-8 percent moisture content. A higher addition rate of thermoactive material tends to lower the equilibrium point and further increase chemical bonding efficiencies which creates high degrees of water resistance and mechanical strength.

Vacuum or suction techniques can also be applied to extract water from the biopolymer as well as other impurities or gases. In an embodiment, heat, vacuum, and mechanical techniques can be employed together to extract water and other matter from the biopolymer. In an embodiment, closed cells can be ruptured through application of one or more of heat, compression, and vacuum suction.

Techniques for extraction of water from polymeric materials are further described in U.S. Pat. No. 6,280,667, which is incorporated herein by reference. This patent propylene discloses methods and apparatus employed for processing plastics with wood fillers. These methods and apparatus can also be employed to process and form embodiments of the present biopolymer.

Making Articles from the Biopolymer

The present biopolymer can be suitable for forming (e.g., by extruding or molding) into a myriad of forms and end products. For forming, the biopolymer can be in any of a variety of forms, such as particles, granules, or pellets. Articles, such as bars, sheet stock, or other formed articles can be produced from the present biopolymer through any of a variety of common, known manufacturing methods including extrusion molding, injection molding, blow molding, compression molding, transfer molding, thermoforming, casting, calendering, low-pressure molding, high-pressure laminating, reaction injection molding, foam molding, or coating. For example, the present biopolymer can be formed into articles by injection molding, extrusion, compression molding, other plastic molding processes, or with a robotically controlled extruder such as a mini-applicator. The present biopolymer including prolamin can be employed in, for example, paints, adhesives, coatings, powder coatings, plastics, polymer extenders, or the like.

In an embodiment, the formed biopolymer can be coated employing any of a variety of coating technologies (e.g., powder coating). Powder coating can not be employed on most conventional plastics including conventional plant materials, such as wood plastic composite or aggregate materials.

In an embodiment, the present biopolymer can be produced as material that has a speckled appearance. This speckled material can be formed by any conventional methods into slabs, boards, panels, and the like for decorative applications in a home or commercial environment. Further, the speckled biopolymer can be formed into individual articles for which a speckled appearance is desirable.

Numerous articles that can be made from or that can include the present biopolymer are described in U.S. patent application Nos. 10/868,276 and 10/868,263 filed Jun. 14, 2004 and entitled BIOPOLYMER STRUCTURES AND COMPONENTS and BIOPOLYMER STRUCTURES AND COMPONENTS INCLUDING COLUMN AND RAIL SYSTEM, respectively, the disclosures of which are incorporated herein by reference.

Foaming the Biopolymer

In an embodiment, the present biopolymer can be foamed either from its soft, raw form or upon melting without addition of foaming or blowing agents. Surprisingly, the present biopolymer can foam upon extruding even in the absence of foaming agents to produce a rigid, strong hardened foam. Although not limiting the present invention, it is believed that the present foam can result from foaming of protein in the prolamin.

The stiff or solid foam can exhibit greater strength (e.g., flexural modulus) compared to conventional foamed plastics at the same density. Conventional plastics decrease in strength when foamed. Although not limiting to the present invention, it is believed that the present biopolymer foam may include denatured protein interacting with the thermoactive material to create an advantageously strong biopolymer foam.

Although not limiting to the present invention, it is believed that the protein component of the prolamin can participate in foaming of the present biopolymer. This belief comes by analogy to foaming of cream to make whipped cream or foaming of egg whites to make meringue or angel food cake. Conventional foaming of proteinaceous materials employs up to about 50 wt-% of the weight of the material. The present biopolymer can include up to about 50 wt-% or more of protein from the prolamin. It is believed that the protein may foam upon application of kinetic energy during forming the present biopolymer. In the presence of thermoactive material, it is believed that this can yield stiff or solid foam.

The present biopolymer (e.g., in the form of pellets) can be converted to a biopolymer foam by injection molding, extrusion, and like methods employed for forming plastics. Although not limiting to the present invention, it is believed that the heat and kinetic energy applied in these processes, such as by a mixing screw, is sufficient to foam the present biopolymer. In injection molding, the mold can be partially filled to allow the foaming action of the biopolymer to fill the cavity. This can decrease the density of the molded article without using chemical foaming or blowing agents. Extruding can also be employed to foam the present biopolymer. The dies used in extruding can form the foamed biopolymer.

Extruding the Biopolymer

The present biopolymer can be extruded to form an article of manufacture employing any of a number of conventional extrusion processes. For example, the present biopolymer can be extruded by dry process extrusion. For example, the present biopolymer can be extruded using any of a variety of conventional die designs. In an embodiment, extruding the present biopolymer to form an article can include feeding the biopolymer into a material preparation auger and converting it to a size suitable for extruding. Extruding can employ any of a variety of conventional dies and any of a variety of conventional temperatures.

Injection Molding the Biopolymer

The compounded biopolymer can be ground to form uniform pellets for use in an injection molding process. In an embodiment, the present biopolymer can exhibit faster heating and cooling times during injection molding compared to conventional thermoplastics. In an embodiment, the present biopolymer maintains the melt index of the plastic and allows flowability characteristics that allows high speed injection molding. For example, it is believed that the present biopolymer including prolamin and polypropylene can have higher thermal conductivity than pure polypropylene. Higher thermal conductivity provides faster heating and/or cooling, which can which can speed processes such as injection molding. In an embodiment, injection molding the present biopolymer can consume less energy than injection molding thermoactive material or filled thermoplastic material.

Appearance Treating the Biopolymer

The biopolymer can be treated for appearance during or after forming. For example, the die or other surface used in forming can form a textured surface on the biopolymer article. Extruding can co-extrude an appearance layer over a biopolymer core. After forming, the formed biopolymer can be treated with a multi roller printing process to impart the look of real wood or other desired printed textures or colors. After forming, the formed biopolymer can be treated with a thermosetting powder. The thermosetting powder can be, for example, clear, semi-transparent, or fully pigmented. The powder can be heat cured, which can form a coating suitable for interior or exterior uses. The powder can also be textured to provide, for example, a natural wood look and texture.

Thermoactive Material Including the Biopolymer

The present biopolymer can be suitable for compounding with any of a variety of thermoactive materials and can provide advantageous characteristics to the resulting modified thermoactive material. A thermoactive material including an added portion of the present biopolymer can be envisioned to include the present biopolymer as an additive. In an embodiment, the modified thermoactive material can have advantageously increased thermal conductivity compared to the thermoactive material lacking the biopolymer. In an embodiment, the modified thermoactive material can have advantageous flow characteristics compared to the thermoactive material lacking the biopolymer. In an embodiment, the modified thermoactive material can have increased thermal stability compared to the thermoactive material lacking the biopolymer. In an embodiment, the modified thermoactive material can have increased mechanical strength compared to the thermoactive material lacking the biopolymer. The present biopolymer can be added to the thermoactive material before making an article from the modified material.

The present modified thermoactive material can be employed for forming (e.g., by extruding or molding) into a myriad of forms and end products. For forming, the present modified thermoactive material can be in any of a variety of forms, such as particles, granules, or pellets. Articles, such as bars, sheet stock, or other formed articles can be produced from the present modified thermoactive material through any of a variety of common, known manufacturing methods including extrusion molding, injection molding, blow molding, compression molding, transfer molding, thermoforming, casting, calendering, low-pressure molding, high-pressure laminating, reaction injection molding, foam molding, or coating. For example, the present modified thermoactive material can be formed into articles by injection molding, extrusion, compression molding, other plastic molding processes, or with a robotically controlled extruder such as a mini-applicator.

In an embodiment, the present modified thermoactive material includes about 1 to about 50 wt-% of the present biopolymer. In an embodiment, the present modified thermoactive material includes about 2.5 to about 50 wt-% of the present biopolymer. In an embodiment, the present modified thermoactive material includes about 10 to about 50 wt-% of the present biopolymer. In an embodiment, the present modified thermoactive material includes about 20 to about 50 wt-% of the present biopolymer. In an embodiment, the present modified thermoactive material includes about 30 to about 50 wt-% of the present biopolymer. In an embodiment, the present modified thermoactive material includes about 1, about 2.5, about 10, about 20, about 30, or about 50 wt-% of the present biopolymer. The present modified thermoactive material can include any of these ranges or amounts not modified by about.

In an embodiment, the present biopolymer can be of a size of about 200 mesh for use as an additive.

In an embodiment, the present modified thermoactive material includes biopolymer including DDG. In an embodiment, the present modified thermoactive material includes biopolymer including distiller's dried corn.

In an embodiment, the present invention includes a method of making a modified thermoactive material. Such a method can include combining (e.g., mixing dry materials) about 50 to about 99 wt-% thermoactive material and about 1 to about 50 wt-% of the present biopolymer. Such a method can include combining (e.g., mixing dry materials) about 50 to about 97.5 wt-% thermoactive material and about 2.5 to about 50 wt-% of the present biopolymer. Such a method can include combining (e.g., mixing dry materials) about 50 to about 90 wt-% thermoactive material and about 10 to about 50 wt-% of the present biopolymer. Such a method can include combining (e.g., mixing dry materials) about 50 to about 80 wt-% thermoactive material and 20 to about 50 wt-% of the present biopolymer. Such a method can include combining (e.g., mixing dry materials) about 50 to about 70 wt-% thermoactive material and about 30 to about 50 wt-% of the present biopolymer. The present method can employ any of these ranges or amounts not modified by about.

Embodiments of the Modified Thermoactive Material

In an embodiment, thermoactive material such as polypropylene with, for example, 10 wt-% of the present biopolymer as an additive exhibited a decrease of about 35 to about 80 % in the length of the cooling cycle.

In an embodiment, the present biopolymer can be envisioned or considered as a nucleating agent, e.g., a hyper nucleating agent, for the thermoactive material.

### EXAMPLES

### Example 1

### Biopolymer Production by Thermal Kinetic Compounding

The present example describes preparation of a biopolymer according to the present invention and that can include prolamin and polypropylene. Compounding was conducted at 3700 RPM; the material was ejected from the compounder at a temperature of 190° C. The polypropylene was a commercial product called SB 642 and supplied by Basell Corporation. The biopolymer left the compounder as a dough like mass that resembles bread dough (soft or raw biopolymer) with some detectable particles of prolamin that had not totally blended into the thermoactive material. The soft or raw biopolymer was granulated in a conventional knife grinding system to create pellets. The pellets were extruded to form a profiled article.

Pellets of the present biopolymer can be injection molded in a standard “dogbone” mold on a Toshiba Electric Injection molding press at a temperature in all three zones of 320° F. As a control, the commercial polypropylene alone can also molded by the same procedure. The resulting dogbones can be tested in accordance to ASTM testing standards for plastic for tensile strength, flexural modulus, modulus of rupture to determine mechanical strengths.

### Example 2

### Biopolymer Production by Extrusion

The following extrusion parameters can be employed for producing a biopolymer according to the present invention.

| Conical Counter Rotating Extruder | |
|---|---|
| RT (Resin Temperature) | 178 C. |
| RP (Resin Pressures) | 11.9 |
| Main Motor (%) | 32.3% |
| RPM | 3.7 |
| D2 (Die Temperature Zone 2) | 163 |
| D1 (Die Temperature Zone 1) | 180 |
| AD (Die) | 180 |
| C4 (Barrel Heating Zone 4) | 177 |
| C3 | 181 |
| C2 | 194 |
| C1 | 208 |
| Screw Temperature | 149 |

(Temperature in Degrees C.)

(Equipment TC85 milicron CCRE)

An admixture of 15% polypropylene (“PP”) and 85% prolamin can be blended @ 7% MC and then can be compounded using a high shear compounding system. The biopolymer can then be extruded at the above processing parameters through a hollow die system.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “adapted and configured” describes a system, apparatus, or other structure that is constructed or configured to perform a particular task or adopt a particular configuration to. The phrase “adapted and configured” can be used interchangeably with other similar phrases such as arranged and configured, constructed and arranged, adapted, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

What is claimed is:

1. A composition comprising:
about 5 to about 95 wt-% prolamin; and
about 1 to about 95 wt-% thermoactive material.

2. The composition of claim 1, comprising:
about 50 to about 70 wt-% prolamin; and
about 20 to about 50 wt-% thermoactive material.

3. The composition of claim 1, wherein the thermoactive material comprises at least one of thermoplastic, thermoset material, and resin and adhesive polymer.

4. The composition of claim 1, wherein the thermoactive material comprises at least one of polyethylene, polypropylene, and polyvinyl chloride.

5. The composition of claim 1, wherein the thermoactive material comprises at least one of epoxy material and melamine.

6. The composition of claim 1, wherein the thermoactive material comprises at least one of polyester, phenolic polymer, and urea containing polymer.

7. The composition of claim 1, wherein the composition is in the form of an integral biopolymer, a composite biopolymer, or an aggregate biopolymer.

8. The composition of claim 1, wherein the composition is in the form of a composite biopolymer and the composite biopolymer has a speckled appearance.

9. The composition of claim 1, wherein the composition is in the form of a pellet, a granule, an extruded solid, an injection molded solid, a hard foam, a sheet, a dough, or a combination thereof.

10. The composition of claim 1, wherein the composition is macroscopically homogeneous.

11. The composition of claim 1, comprising covalent bonding of the prolamin to the thermoactive material.

12. The composition of claim 1, comprising a melt of the prolamin and the thermoactive material.

13. The composition of claim 1, further comprising at least one of dye, pigment, hydrolyzing agent, plasticizer, filler, preservative, antioxidants, nucleating agent, antistatic agent, biocide, fungicide, fire retardant, flame retardant, heat stabilizer, light stabilizer, conductive material, water, oil, lubricant, impact modifier, coupling agent, crosslinking agent, blowing or foaming agent, and reclaimed or recycled plastic.

14. The composition of claim 1, further comprising at least one of plasticizer, light stabilizer, and coupling agent.

15. An article comprising a composition, the composition comprising:
about 5 to about 95 wt-% prolamin; and
about 1 to about 95 wt-% thermoactive material.

16. A method of making a composition, the method comprising compounding material comprising prolamin and thermoactive material.

17. The method of claim 16, wherein compounding comprises thermal kinetic compounding.

18. The method of claim 16, wherein compounding comprises twin screw extruding.

19. The method of claim 18, wherein twin screw extruding comprises foaming the composition.

20. The method of claim 16, further comprising hardening the composition.

21. The method of claim 20, further comprising grinding the hardened composition.

22. The method of claim 21, comprising grinding the composition to form granule.

23. The method of claim 20, further comprising forming the composition into pellet.

24. The method of claim 20, further comprising forming the composition into sheet.

25. The method of claim 16, comprising compounding a mixture comprising:
about 5 to about 95 wt-% prolamin; and
about 0.1 to about 95 wt-% thermoactive material.

26. The method of claim 25, comprising compounding a mixture comprising:
about 50 to about 70 wt-% prolamin; and
about 20 to about 50 wt-% thermoactive material.

27. The method of claim 16, comprising compounding prolamin and at least one of thermoplastic, thermoset material, and resin and adhesive polymer.

28. The method of claim 16, comprising compounding prolamin and at least one of polyethylene, polypropylene, polyvinyl chloride, epoxy material, melamine, polyester, phenolic polymer, and urea containing polymer.

29. The method of claim 16, wherein compounding produces a composition that is macroscopically homogeneous.

30. The method of claim 16, wherein compounding induces covalent bonding of the prolamin to the thermoactive material.

31. The method of claim 16, wherein compounding raises the temperature of the prolamin to a temperature greater than T_{g} of the prolamin.

32. The method of claim 16, wherein compounding raises the temperature of the prolamin to a temperature greater than Tₘ of the prolamin.

33. The method of claim 16, further comprising coating the compounded composition.

34. A method of making a foamed composition, the method comprising:
extruding material comprising prolamin and thermoactive material; and
producing a foamed composition comprising prolamin and thermoactive material.

35. The method of claim 34, comprising extruding a composition free of added foaming or blowing agent.

36. A method of making an article, the method comprising:
forming the article from a composition comprising:
about 5 to about 95 wt-% prolamin; and
about 0.1 to about 95 wt-% thermoactive material.

37. The method of claim 36, wherein forming comprises one or more of extrusion molding, injection molding, blow molding, compression molding, transfer molding, thermoforming, casting, calendering, low-pressure molding, high-pressure laminating, reaction injection molding, foam molding, and coating.

38. The method of claim 36, further comprising coating the article.
